(19) United States
(12) Patent Application Publication
(10) Pub. No.: US 2007/0237881 A1
(43) Pub. Date: Oct. 11, 2007

(54) Rainbow cake - process of creating rainbow effect

(76) Inventor: Annette Marques, Port St. Lucie, FL (US)

Correspondence Address: ANNETTE MARQUES, 1242 SW SAN ANTONIO AVE, PORT ST. LUCIE, FL, 34953, US

(21) Appl. No.: 11/397,397

(22) Filed: Apr. 5, 2006

(51) Int. Cl. A21D 2/00

(52) U.S. Cl. 426/622

(57) ABSTRACT

A process to create a unique and distinctive colorful marbled rainbow effect for a cake. Many cakes are marbled but this process will be unique and distinctive each time.

The following ingredients will be mixed by hand or with an electrical mixer

Ingredients

| | |
|---|---|
| 2 cups margarine | 4 cups all purpose or cake flour |
| 2 cups sugar 4 large eggs | 4½ tsp baking powder |
| 2 tsp vanilla essence, | 3 tsp almond essence |
| 2 tsp nutmeg | 1 tsp cinnamon powder |
| ¼ cup milk | 4 edible food coloring - red green |
| | yellow brown |
| Greased 8 × 3 inch cake pan | 1 round tip dinner knife |

In a large bowl, cream butter and sugar until creamy. Add eggs one at time until mixture is thick, and then add almond essence and vanilla. In a separate bowl sift baking powder together with cinnamon powder and nutmeg; add this to the cream mixture with milk. Mix until smooth.

### PROCESS OF CREATING RAINBOW EFFECT

Divide batter into 4 bowls—to one add Green coloring—one Yellow—one Red—one Brown. (Brown will have a little less batter). Pour half of Yellow batter into the cake tin first, then layer red mixture over the yellow, brown over the red, green over the brown and lastly layer the other half of the yellow batter over the green. (In order, this should be yellow, red, brown, green, yellow). This can also be done with three colors if preferred (yellow, red, green and yellow in this order).

Take the dinner knife and from the center of the layered mixture make about eight circular turns. (This will bring you from center of mixture to outwards), go back to the center and slowly turn the mixture again only this time bringing the mixture from the bottom to top with the knife and turning (or folding) over the colors as you go along. (This will be like folding the mixture). Do this until the whole of mixture is done. Bake at 325 degrees for 1 hr increasing temperature to 370 degrees for 15 minutes. Use cake tester to determine if cake is done.

All purpose or cake flours may be used, but with this process a unique and distinctive kaleidoscope of colors is achieved each time.

### DESCRIPTION OF THE SEVERAL VIEWS OF THE DRAWING

FIG. 1-4 color illustration demonstrates the different mixture of colors both outside and inside of cake

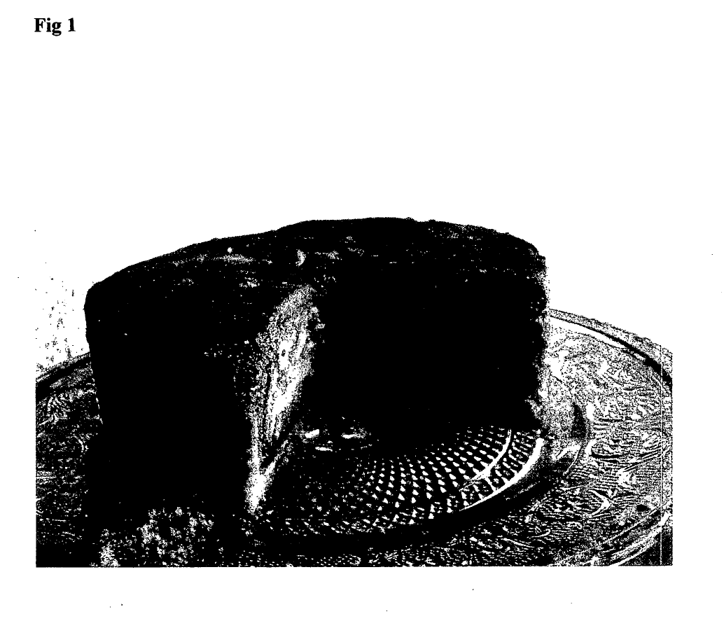

FIG. 2-4 color illustration demonstrates a closer look at the mixture of colors

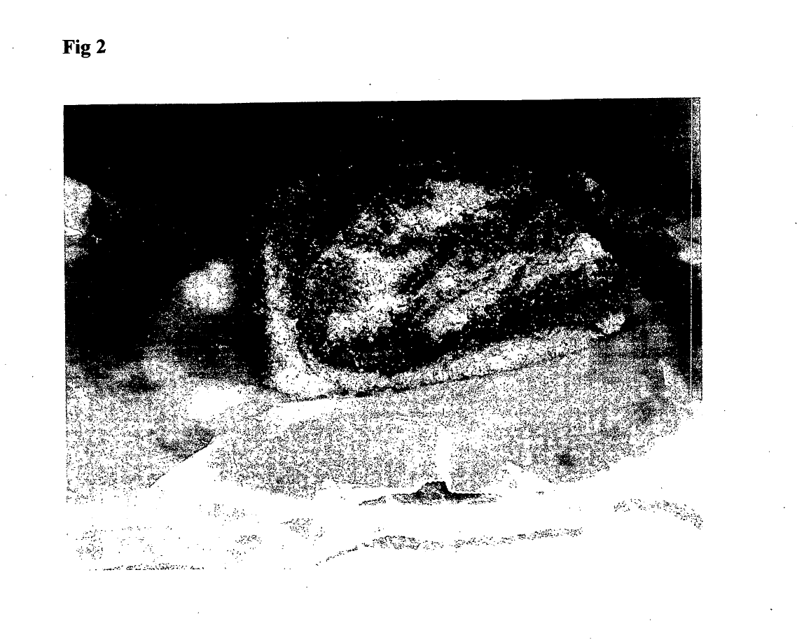

FIG. 3-4 color illustration demonstrates a different mixture of colors

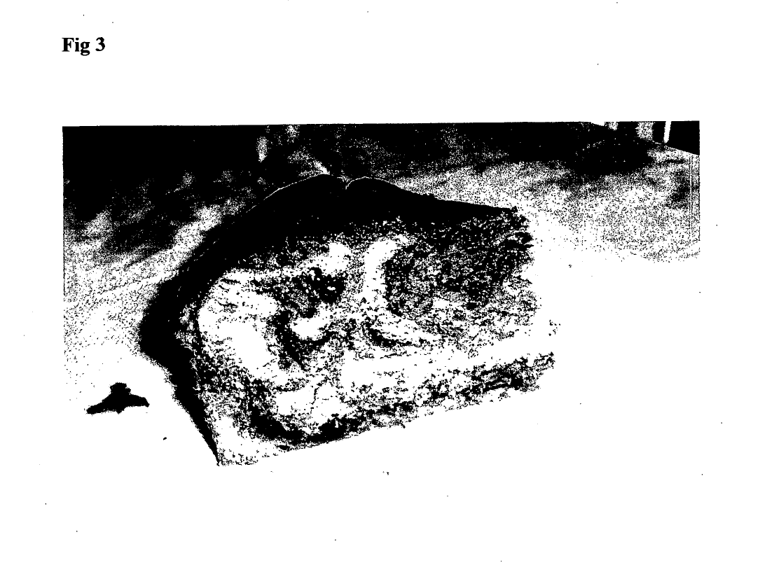

FIG. 4-4 color illustration demonstration of obtaining a different mixture of colors each time

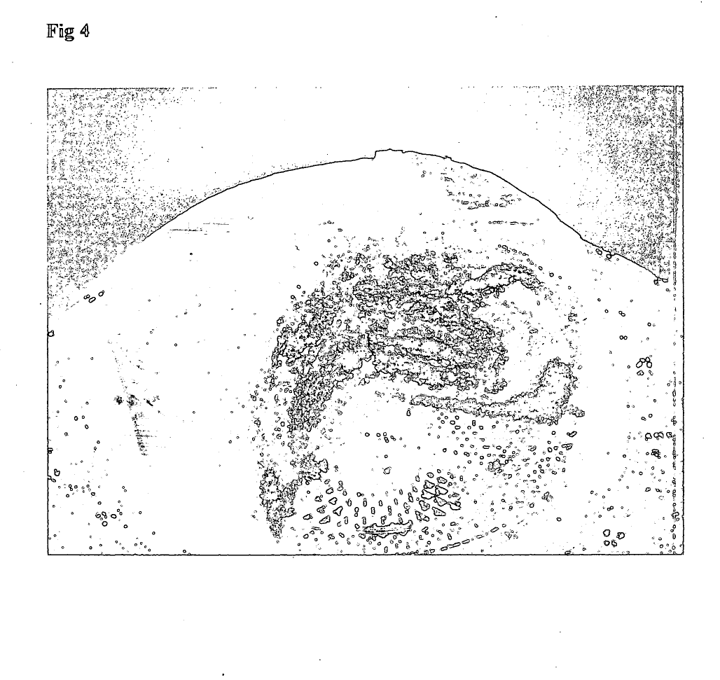

FIG. 5-3 color illustration demonstrates a mixture of colors throughout the mixture

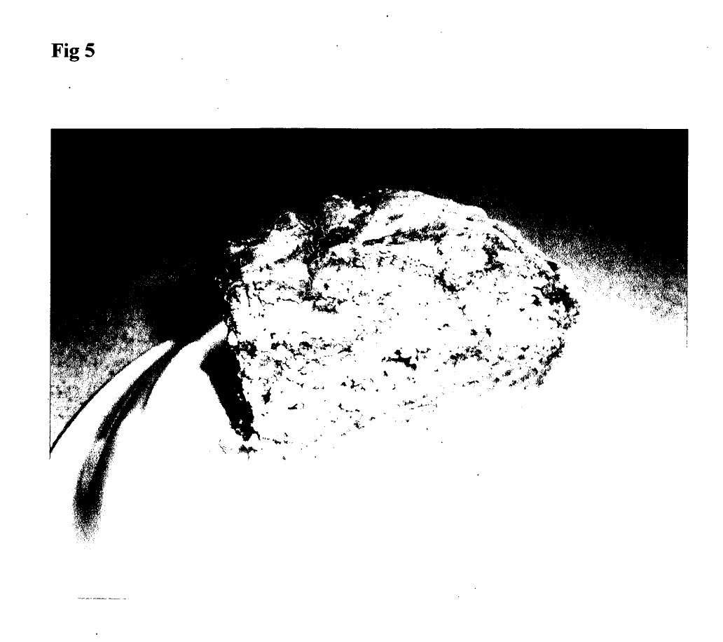

What is claim is:

1. A process for producing a constant rainbow like effect by the layering and mixing of colors that will create a unique and distinctive colorful marbled rainbow effect for a cake. When using this mixing method you will be guaranteed this distinctive colorful unique effect each time.
